(19) United States
(12) Patent Application Publication
(10) Pub. No.: US 2007/0248182 A1
(43) Pub. Date: Oct. 25, 2007

(54) Recovering data and clock from T1 signals

(75) Inventors: Luiz Fernando Copetti, Curitiba-Pr (BR); Wilson Ronald Keune, Curitiba-Pr (BR); Jorge Tortato JR., Curitiba-Pr (BR)

Correspondence Address: SIEMENS SCHWEIZ AG;I-47, INTELLECTUAL PROPERTY, ALBISRIEDERSTRASSE 245, ZURICH, CH-8047, CH

(73) Assignee: SIEMENS AKTIENGESELLSCHAFT, MUNICH (DE)

(21) Appl. No.: 11/407,757

(22) Filed: Apr. 20, 2006

(51) Int. Cl. H04L 25/34

(52) U.S. Cl. 375/289

(57) ABSTRACT

In a method for recovering clock and data from T1 signals, an analog T1 signal is compared with positive and negative thresholds to obtain a positive bipolar signal and a negative bipolar signal. From the bipolar signals, pulses whose duration is below a minimum width value v1 are removed to obtain positive and negative filtered signals. The filtered signals are processed to obtain edge signals. Pulses of the edge signals correspond to transitions of the filtered signals after an inactivity period greater than a minimum inactivity value v2. From the filtered signals, long pulses having a duration greater than a long pulse value v3 are detected to obtain a long pulse signal. A recovered clock signal is recovered by dividing a high-frequency reference clock down to a lower frequency value, and by synchronizing the recovered clock signal with the edge signals and with the long pulse signal. From the filtered signals, recovered data signals triggered by the recovered clock signal are recovered.

### BACKGROUND OF THE INVENTION

The present invention generally relates to a method and system for recovering digital data and clock from T1 signals in T1 equipments.

T1 equipments may comprise PDH and SDH multiplex systems or any other system that has a T1 line interface attached to itself. Typically, it is at T1 line interface circuits that the analog T1 electrical signals are processed in order to recover digital clock and data information.

A critical issue in performing such T1 signal processing is to determine the appropriate threshold values for detecting the high and the low data pulses of the T1 signals. In fact, as defined by the ITU-T Recommendation G.703, ITU-T Recommendation G.703 (“Physical/electrical characteristics of hierarchical digital interfaces”) and by standard ANSI T1.102 (“Digital Hierarchy—Electrical Interfaces”), the T1 pulse mask has high undershoot values and it can operate in a relatively wide range of voltage levels. FIG. 1 shows an example of a T1 mask format taken from the above mentioned ITU-T G.703 recommendation. FIG. 1 is taken from FIG. I.1/G.703 of the above mentioned ITU-T G.703 recommendation which is a worse case example than the T1 mask example defined in FIG. 10/G.703 of the above mentioned ITU-T G.703 recommendation. In FIG. 1, the maximum and minimum voltage levels are shown in a normalized amplitude scale and the time is shown in a time unit interval scale, in which a time unit is 1/1544 KHz=648 ns. Table 1, which is also taken from FIG. I.1/G.703 of the above mentioned ITU-T G.703 recommendation, shows the corner point values of the T1 pulse mask of FIG. 1.

TABLE 1

| | |
|---|---|
| Minimum Curve | Maximum Curve |

| | Normalized | | Normalized |
|---|---|---|---|
| Time | Amplitude | Time | Amplitude |
| −0.77 | −0.05 | −0.77 | 0.05 |
| −0.23 | −0.05 | −0.39 | 0.05 |
| −0.23 | 0.5 | −0.27 | 0.8 |
| −0.15 | 0.95 | −0.27 | 1.22 |
| −0.04 | 0.95 | −0.12 | 1.22 |
| 0.15 | 0.9 | 0.0 | 1.05 |
| 0.23 | 0.5 | 0.27 | 1.05 |
| 0.23 | −0.62 | 0.34 | 0.08 |
| 0.42 | −0.62 | 0.58 | 0.05 |
| 0.66 | −0.2 | 1.16 | 0.05 |
| 0.93 | −0.05 | | |
| 1.16 | −0.05 | | |

Because of the high undershoot values of the T1 mask, known methods for recovering digital data and clock from T1 signals require complex analog dynamic circuits, such as for example analog equalizers and analog automatic gain control (AGC) circuits, for determining the appropriate threshold values.

FIG. 2 shows a block diagram of a T1 line interface unit as it is typically defined in prior art system. An analog T1 stream input signal T1I is firstly processed by a transform module T that performs the typical known operations of transform coupling and impedance matching. The analog T1 stream T1I input contains a sequence of T1 data pulses in which the T1 mask is the one defined in FIG. 1. Transform output signal AI exits the transform module T and enters an analog AGC or an analog equalizer AGC/EQ, attenuating or amplifying the transform output signal AI, prior to other processing, to allow proper signal recovery. Output signal PI from the analog AGC or the analog equalizer AGC/EQ enters a peak detection and slicer module PDS. Output signal CI from the peak detection and slicer module PDS enters a clock and data recovery module CDR. The clock and data recovery module CDR uses a high frequency reference clock HCKp. Output signals RCKp, Rap, Rbp of the clock and data recovery module CDR represent recovered clock and data signals by the clock and data recovery module. Dashed feedback line FL is optionally implemented and represents a feedback channel FL for tuning the gain of the analog AGC or the analog equalizer AGC/EQ.

Several drawbacks of using complex analog dynamic circuits at T1 line interfaces, as the one shown in the prior art implementation of FIG. 2, exist. A first drawback is that the presence of complex analog dynamic circuits increases the overall required circuit space. A second drawback is that the presence of complex analog dynamic circuits increases the cost of the T1 line interface circuitry. A third drawback is that, when complex analog dynamic circuits are used, the allowed line card density is reduced.

Attempts have been made to use fixed voltage level thresholds via simple analog comparators to determine whether the incoming signals are high or low. Unfortunately, such attempts have the drawback of having poor performances with the high undershoot voltage values of the T1 pulse mask of FIG. 1 and Table 1. In fact, on one hand, if, within the analog comparator, the negative and the positive fixed threshold have high absolute values, the circuit for recovering data and clock is not able to detect attenuated signals. On the other hand, within the analog comparator, the negative and the positive fixed threshold have high absolute values, the undershoot pulse leads to erroneous pulse detections by the circuit for recovering digital clock and data.

Simple recovering methods and systems having high performances are desirable.

### SUMMARY OF THE INVENTION

In a method and a system for recovering clock and data from T1 signals, an analog T1 signal is compared with a positive predefined fixed threshold and with a negative predefined fixed threshold, so as to obtain a positive bipolar signal and a negative bipolar signal. The pulses of the positive and negative bipolar signals correspond to portions in which the analog T1 signal is above the positive predefined fixed threshold and to portions in which the analog T1 signal is below the negative predefined fixed threshold, respectively. From the bipolar signals, pulses whose duration is below a predefined minimum width value v1 are removed so as to obtain a positive filtered signal and a negative filtered signal. The filtered signals are processed so as to obtain edge signals; wherein pulses of the edge signals correspond to valid input transitions of the filtered signals which are coming after an inactivity period greater than a predefined minimum inactivity value v2. From the filtered signals, long pulses having a duration greater than a predefined long pulse value v3 are detected, so as to obtain a long pulse signal. A recovered clock signal is recovered by dividing a high-frequency reference clock down to a lower frequency value, and by synchronizing the recovered clock signal with the edge signals and with the long pulse signal. From the filtered signals, recovered data signals triggered by the recovered clock signal are recovered.

The proposed invention guarantees high performances while minimizing the complexity of the external analog circuits required at T1 line interfaces.

The proposed invention allows implementing T1 line interface circuits by using digital circuits coupled with simple analog comparators with fixed voltage level thresholds. Thus, the proposed invention leads to space and cost reductions at T1 line interface circuits.

The various features and advantages of this invention will become apparent to those skilled in the art from the following detailed description of the currently preferred but not exclusive embodiment. The drawings that accompany the detailed description can be briefly described as follows.

### BRIEF DESCRIPTION OF THE SEVERAL VIEWS OF THE DRAWING

FIG. 1 is a chart of a T1 pulse mask taken from the above mentioned ITU-T G.703 recommendation;

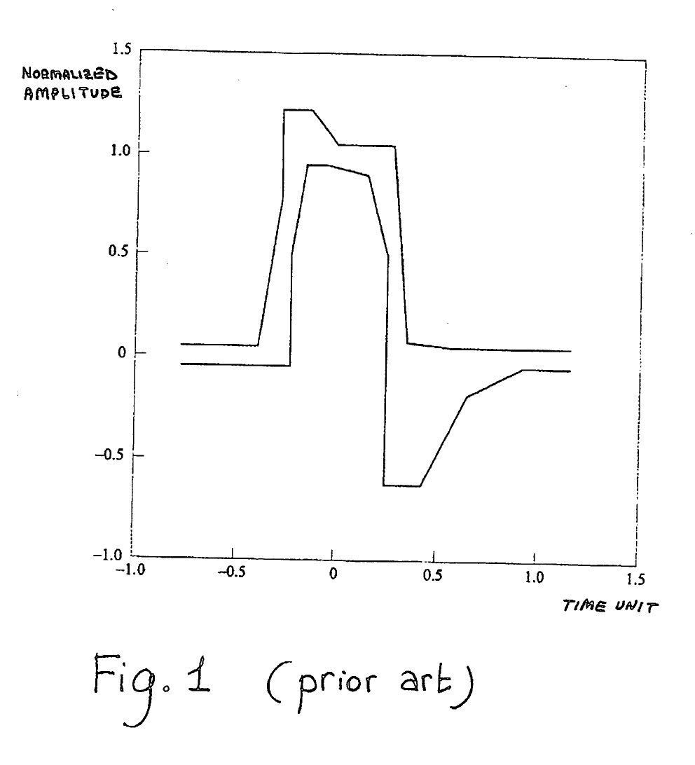

FIG. 2 is a block diagram of a T1 line interface unit as in the prior art;

FIG. 3 is a block diagram of a T1 line interface unit in an example embodiment according to the present invention;

FIG. 4 is a chart of a T1 pulse mask with fixed decision levels according to an example embodiment of the present invention;

FIG. 5 are waveforms of examples of input and output signals to/from an analog comparator;

FIG. 6 are waveforms of extracted data from a T1 signal according to an example embodiment of the present invention;

FIG. 7 is a flow chart detailing steps performed in digital device DD of FIG. 3.

### DETAILED DESCRIPTION OF THE INVENTION

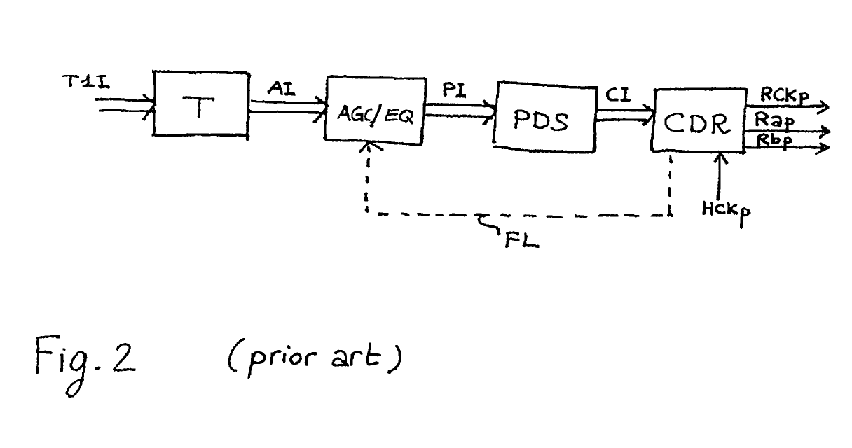

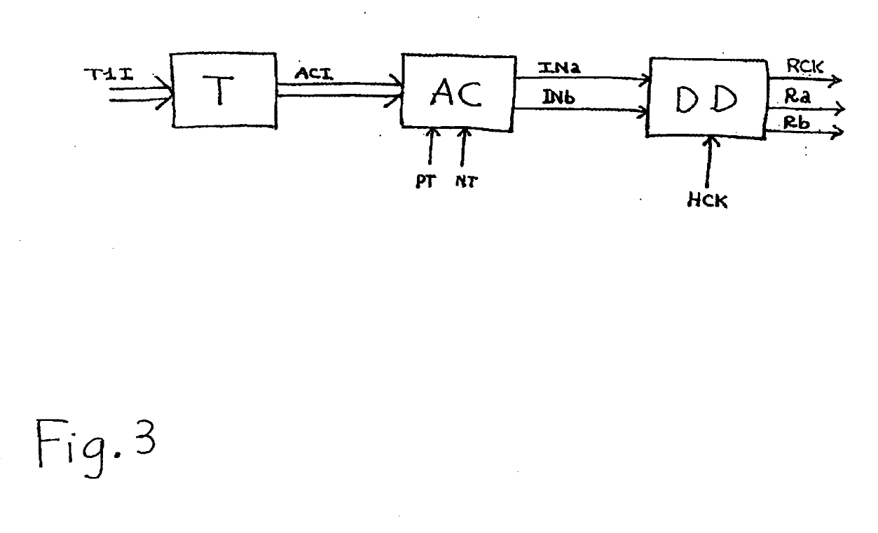

FIG. 3 shows a block diagram of a T1 line interface unit in one embodiment according to the present invention. Analog T1 stream input T1I and transform module T correspond to the ones shown in the prior art T1 interface block diagram depicted in FIG. 2.

Comparator input signal ACI enters a fixed threshold analog comparator AC. The analog comparator AC operates by using two fixed voltage threshold levels PT, NT, a positive level PT and a negative level NT. The two threshold levels PT, NT may have opposite sign and different or same absolute values.

Comparator output signals INa, INb enter a digital device DD. The digital device DD makes use of a high-frequency reference clock HCK. The frequency of the high-frequency reference clock HCK should be at least 8 times higher than 1544 kHz and best if it is equal or higher than 32×1544 kHz=49408 kHz. Digital device output signals CK, Ra, Rb are the recovered digital clock RCK and recovered digital data Ra, Rb resulting from the present recovering method and system.

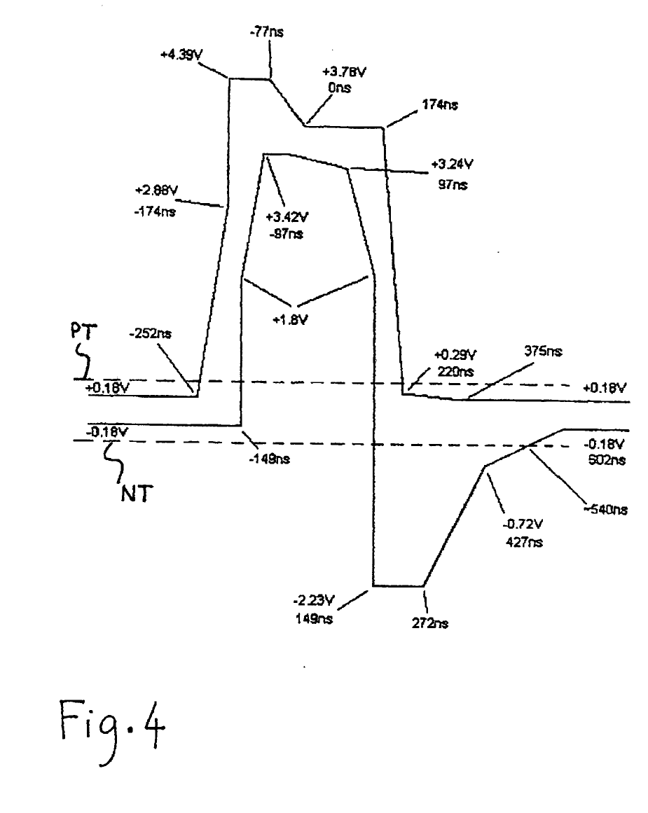

FIG. 4 shows the T1 pulse mask corner values, in Volt [V] and nano-seconds [ns], and two decision level thresholds PT, NT for the fixed threshold analog comparator AC, marked with a dashed line, according to an example embodiment of the present invention.

The voltage decision levels PT, NT for the analog comparator AC are set as having the lowest possible absolute value for having good performances, so as to allow recognizing attenuated signal as well as strong ones. For example, values of preferred fixed threshold levels may be comprised in the range α=[−0.6 V, 0.6 V].

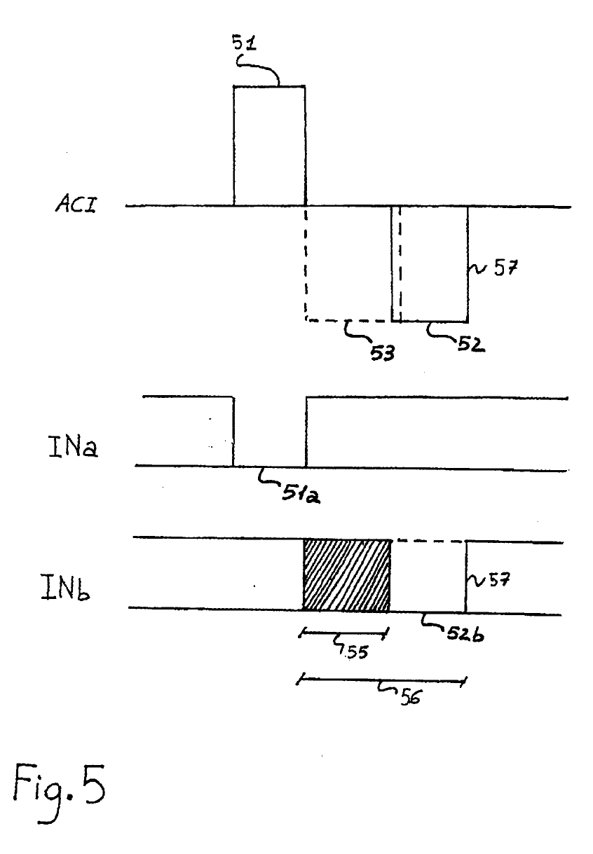

FIG. 5 shows an example of waveforms of comparator input signal ACI and corresponding comparator output bipolar signals INa, INb. The comparator input signal ACI is compared to the predetermined dashed fixed threshold levels NT, PT of FIG. 4. The two comparator output signals INa, INb represent the two digital bipolar signals INa, INb, a bipolar positive signal INa and a bipolar negative signal INb. In FIG. 5, the output bipolar signals INa, INb are represented in a commonly used inverted format in which the low pulses of the positive bipolar signal INa and the low pulses of the negative bipolar signal INb represent periods in which the comparator input signal ACI is above the positive threshold PT and below the negative threshold NT, respectively. One skilled in the art will understand that in a further embodiment according the present invention the bipolar signals INa, INb may be represented in a non-inverted format in which high pulses represent high and low peaks of the comparator input signal ACI.

In FIG. 5, the continuous line pulses of the comparator input signal ACI represent valid positive and negative pulses 51, 52. Dashed line 53 of the comparator input signal ACI represents the maximum undershoot signal duration following the positive pulse 51. Similarly, negative pulse 52 may be followed by an undesired undershoot positive pulse, not shown in FIG. 5. The output positive bipolar signal INa has a low peak 51a in correspondence with the input positive pulse signal 51, beginning at edge 58 and lasting until the end of period 51a. Similarly, the negative bipolar signal INb has a low peak 52b in correspondence with the input negative pulse signal 52. In correspondence with the input undershoot area 53, the negative output signal INb has an area of uncertainty 55, dashed area, in which resulting values can oscillate in correspondence with possible oscillation of comparator input signal values ACI. If the uncertainty area 55 becomes a low peak during all its width, 55 and 52b area will become a single larger pulse, or a called long pulse, extended until the end of pulse 52b, at edge 57. Area 56 represents the long pulse result area.

The output bipolar signals INa, INb of the analog comparator AC have a certain behavior that is described by rules defining boundary durations of valid pulses. According to a first rule, a minimum width of a valid pulse has a value which belongs to a first predefined range τ1, e.g. τ1=[275 ns, 325 ns]. According to a second rule, a maximum width of a valid pulse has a value which belongs to a second predefined range τ2, e.g. τ2=[435 ns, 485 ns]. According to a third rule, a maximum undershoot width of a valid pulse has a value which belongs to a third predefined range τ3, e.g. τ3=[365 ns, 415 ns]. According to a forth rule, inside the undershoot area of a pulse, several undesired pulses may be generated. Thus, the signal value inside the undershoot area is “a priori” undefined since the undershoot shape may range from no pulse to a large pulse having the maximum undershoot width. According to a fifth rule, consecutive pulse of opposite polarities, i.e. +1−1 or −1+1, may result in a larger pulse due to the undershoot pulse. One skilled in the art will understand that the numerical values of the three above predefined ranges τ1, τ2, τ3 may vary depending on the choice of the T1 mask and on the choice of the fixed threshold levels PT, NT.

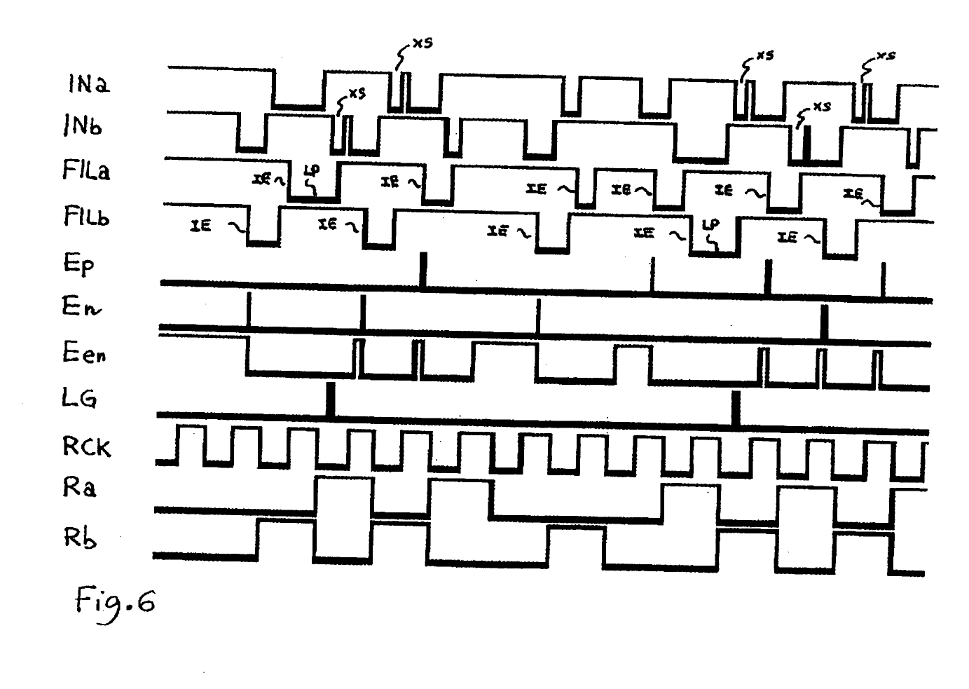

FIG. 6 shows waveforms of extracted signals from a T1 signal according to an example embodiment of the present invention.

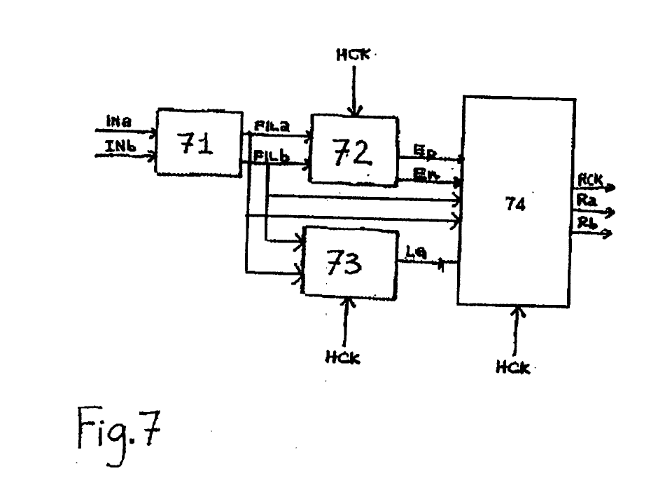

FIG. 7 shows a flow chart detailing the steps performed in the digital device DD of FIG. 4 in order to obtain the recovered digital clock RCK and data Ra, Rb.

In step 71, the comparator output signals INa, INb are processed so that all extremely short pulses XS having a width below a predefined value v1 are removed and corresponding filtered signals FILa, FILb are obtained. The predefined value v1 may be, for example, set to 170 ns or less. FIG. 6 shows examples of extremely short pulses XS present in comparator output signals INa, INb and removed from the corresponding filtered signals FILa, FILb.

In step 72, the filtered signals FILa, FILb are processed so that edge enable signal Een is obtained. The edge enable signal Een, when high, represents the period of time in which input transitions IE in the filtered signals FILA, FILB may be considered valid transitions. The edge enable signal Een enables detection after an inactive period in filtered signals FILA, FILB. An inactivity period is present when both bipolar filtered signals FILa, FILb have a high value for an interval of time larger than the predefined inactivity value v2. The predefined inactivity value v2 may be preferably set to any value comprised between 170 ns and 260 ns. Input edges IE of filtered signals FILa, FILb are not valid if the inactivity line is below a predefined inactivity value v2.

In FIG. 6, the transitions IE are falling input edges of filtered signals FILa, FILb. One skilled in the art will understand that, if an inverted representation of the filtered signals FILa, FILb is used rather than the representation used in FIG. 6, then the transitions IE are the rising and not the falling input edges of filtered signals FILa, FILb.

Edge positive and the edge negative signals Ep, En represent, when high, the detected falling edges, potentially valid, in which enabling signal Een is high, of the positive filtered signal FILa and in the negative filtered signal FILb respectively.

In step 73, long pulses LP are detected. Long pulses LP are defined as pulses having a duration that is greater than a predefined long value v3. The long pulses may occur due to the T1 undershoot pulse. The predefined long value v3 may be preferably set to any value comprised between 480 ns and 520 ns. Long signal LG, when high, represents the detection of such long pulses LP. Long pulses are valid pulses concatenated to undershoot pulses that cannot be detected in step 72.

In step 74, an internal counter divides the high-frequency reference clock HCK down to 1544 kHz for the generation of the recovered clock signal RCK. Each valid edge of filtered signals FILa, FILb, obtained from edge signals Ep, En, or each long pulse LP, detected from long signal LG, resets appropriately an internal counter that generates recovered clock RCK. Thus, by synchronizing the recovered clock RCK with the edge signals Ep, En and with the long signals LG, the frequency of the recovered clock RCK is in turn locked to the frequency of the bipolar signals INa, INb. Reset values for the counter are fixed to result in falling edges near to the center of valid pulses of filtered signals FILa, FILb. The falling edges of clock signal RCK are used to sample filtered signals FILa, FILb signals, resulting in recovered data signals Ra, Rb. In FIG. 6, recovered data signals Ra, Rb are represented inverted from filtered signals FILa, FILb.

In a preferred embodiment of the present invention, steps 72, 73 and 74 may be performed by the digital circuit DD. The digital circuit DD may preferably be implemented as a traditional CMOS device such as for example a Field Programmable Gate Array (FPGA) device. In further embodiment of the present invention, the digital circuit DD may be implemented as a Complex Programmable Logic Device (CPLD), an ASIC, a VLSI device or any other digital semiconductor device.

Although a preferred embodiment of this invention has been disclosed, a worker of ordinary skill in this art would recognize that certain modifications would come within the scope of this invention. For that reason, the following claims should be studied to determine the true scope and content of this invention.

### LIST OF REFERENCE SIGNS

AC analog comparator
ACI input signal of analog comparator AC
AGC/EQ analog AGC or analog equalizer module
AI output signal of transform module T
CDR clock and data recovery module
CI output signal of peak detection and slicer module PDS
DD digital device
Een edge enable signal
En edge negative signal
Ep edge positive signal
FILa positive filtered signal
FILb negative filtered signal
FL feedback line
HCK high-frequency reference clock of digital device DD
HCKp high-frequency reference clock of clock and data recovery module CDR
IE input edge, input transition
INa positive output signal of analog comparator AC
INb negative output signal of analog comparator AC
LG long signal
LP long pulse
NT negative fixed threshold
PI output signal of analog module AGC/EQ
PT positive fixed threshold
Ra recovered data by device DD
Rap recovered data by module CDR
Rb recovered data by device DD
Rbp recovered data by module CDR
RCK recovered clock by device DD
RCKp recovered clock by module CDR
T transform module performing transform coupling and impedance matching
T1I analog T1I stream input signal
XS extra-short pulse
51 input positive pulse
52 input negative pulse
53 maximum undershoot signal duration
55 uncertainty area
56 long pulse result area
57 edge of valid pulse
71 step b)
72 step c)
73 step d)
74 steps e), f)

### LIST OF USED ACRONYMS

AGC automatic gain control
ASIC application specific integrated circuit
PDH plesiochronous digital hierarchy
SDH synchronous digital hierarchy
T1 T-carrier level 1
VLSI very large scale integration

We claim:

1. A method for recovering clock and data from T1 signals, comprising:
a) comparing an analog T1 signal with a positive predefined fixed threshold and with a negative predefined fixed threshold, so as to obtain a positive bipolar signal and a negative bipolar signal; wherein pulses of said positive and negative bipolar signals correspond to portions in which said analog T1 signal is above said positive predefined fixed threshold and to portions in which said analog T1 signal is below said negative predefined fixed threshold, respectively;
b) removing, from said bipolar signals, pulses whose duration is below a predefined minimum width value v1, so as to obtain a positive filtered signal and a negative filtered signal;
c) processing said filtered signals so as to obtain edge signals; wherein pulses of said edge signals correspond to valid input transitions of said filtered signals which are coming after an inactivity period greater than a predefined minimum inactivity value v2;
d) detecting, from said filtered signals, long pulses having a duration greater than a predefined long pulse value v3, so as to obtain a long pulse signal;
e) recovering a recovered clock signal, by dividing down a high-frequency reference clock down to a lower frequency value, and by synchronizing said recovered clock signal with said edge signals and with said long pulse signal; and
f) recovering, from said filtered signals, recovered data signals triggered by said recovered clock signal.

2. The method as recited in claim 1, wherein said lower frequency value is about 1544 kHz.

3. The method as recited in claim 1, wherein said predefined minimum width value v1 is set to less than about 170 ns.

4. The method as recited in claim 1, wherein said predefined minimum inactivity value v2 is comprised between about 170 ns and about 260 ns.

5. The method as recited in claim 1, wherein said predefined long pulse value v3 is comprised between about 480 ns and about 520 ns.

6. The method as recited in claim 1, wherein said steps b) to d) are performed by a digital device.

7. The method as recited in claim 6, wherein said high-frequency reference clock has a frequency higher than about 12352 KHz.

8. The method as recited in claim 1, wherein said predefined fixed thresholds have a value comprised between about −0.6 V and about 0.6 V.

9. A system for recovering clock and data from T1 signals, comprising:
a) means for comparing an analog T1 signal with a positive predefined fixed threshold and with a negative predefined fixed threshold, so as to obtain a positive bipolar signal and a negative bipolar signal; wherein pulses of said positive and negative bipolar signals correspond to portions in which said analog T1 signal is above said positive predefined fixed threshold and to portions in which said analog T1 signal is below said negative predefined fixed threshold, respectively;
b) means for removing, from said bipolar signals, pulses whose duration is below a predefined minimum width value v1, so as to obtain a positive filtered signal and a negative filtered signal;
c) means for processing said filtered signals so as to obtain edge signals; wherein pulses of said edge signals correspond to valid input transitions of said filtered signals which are coming after an inactivity period greater than a predefined minimum inactivity value v2;
d) means for detecting, from said filtered signals, long pulses having a duration greater than a predefined long pulse value v3, so as to obtain a long pulse signal;
e) means for recovering a recovered clock signal, by dividing down a high-frequency reference clock down to a lower frequency value, and by synchronizing said recovered clock signal with said edge signals and with said long pulse signal; and
f) means for recovering, from said filtered signals, recovered data signals triggered by said recovered clock signal.

10. The system as recited in claim 8, wherein said lower frequency value is about 1544 kHz.

11. The system as recited in claim 8, wherein said predefined minimum width value v1 is set to less than about 170 ns.

12. The system as recited in claim 8, wherein said predefined minimum inactivity value v2 is comprised between about 170 ns and about 260 ns.

13. The system as recited in claim 8, wherein said predefined long pulse value v3 is comprised between about 480 ns and about 520 ns.

14. The system as recited in claim 8, wherein said means b) to f) are comprised within a digital device.

15. The system as recited in claim 14, wherein said high-frequency reference clock has a frequency higher than about 12352 KHz.

16. The system as recited in claim 8, wherein said predefined fixed thresholds have a value comprised between about −0.6 V and about 0.6 V.
